(19) United States
(12) Patent Application Publication
(10) Pub. No.: US 2007/0130183 A1
(43) Pub. Date: Jun. 7, 2007

(54) Methods, systems, and computer program products for associating computer-system-accessible resources using behaviors

(76) Inventor: Robert P. Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/291,414

(22) Filed: Dec. 1, 2005

(51) Int. Cl. G06F 7/00

(52) U.S. Cl. 707/101

(57) ABSTRACT

Methods, systems, and computer program products for associating computer-system-accessible resources using behaviors are disclosed. According to one method, first and second resources accessible via a computer system are identified. A behavior for associating the first and second resources at an instance level is determined. The first and second resources are associated using the behavior.

### TECHNICAL FIELD

The subject matter described herein relates to methods, systems, and computer program products for associating resources accessible by a computer system. More particularly, the subject matter described herein relates to methods, systems, and computer program products for associating computer-system-accessible resources using behaviors.

### BACKGROUND

Computer systems make many different resources available to the system user. For example, typical computer systems manage non-executable files, executable files, data made available via an executing file, and file folders. In light of the number of resources that may be managed by a computer system, it may be desirable to organize the resources.

One conventional method for organizing resources is via file folders. For example, typical computer file systems allow users to place files in the folders defining a containment relationship between the file and the file folder. While this relationship is suitable for organizing some resources, it is limited to the file folder resource types. For example, current computer systems do not allow arbitrary resource types to be defined as containment resources for other resource types.

Another problem with existing computer systems, such as the Windows® operating systems that use the WINFS file system, is that these operating systems require relationships between resources to be predefined for the resource types. For example, the only reason that a file can be associated with a file folder using WINFS-based operating systems is the fact that the containment action or behavior is predefined for the file folder type. There is no ability using current computer systems for a user to define a new behavior for a resource, associate that behavior with the resource, and apply that behavior to associate two or more resources.

Yet another problem with existing computer systems is that they do not allow specific behaviors to be defined for resources and used for interaction between and with resources that are associated using the behavior. For example, it may be desirable to define a containment behavior for associating two resources that did not previously have a containment behavior and to use the behavior for navigating between the resources. As stated above, current computer systems require that the containment behavior be defined by the operating system programmer and that behavior is limited to file folder resource types.

Accordingly, in light of these difficulties associated with conventional computer systems, there exists a need for methods, systems, and computer program products for associating computer-system-accessible resources using behaviors.

### SUMMARY

According to one aspect, the subject matter described herein includes a method for associating computer-system-accessible resources using behaviors. According to one method, first and second resources accessible via a computer system are identified. A behavior for associating the first and second resources at an instance level rather than at the resource type level is determined. As used herein, the term “behavior” refers to an action defined or selected by a user or an application that creates a relationship between resources. The first and second resources are associated using the behavior.

The subject matter described herein for associating computer-system-accessible resources using behaviors may be implemented using a computer program product comprising computer executable instructions embodied in a computer readable medium. Exemplary computer readable media suitable for implementing the subject matter described herein include chip memory devices, disk memory devices, application specific integrated circuits, programmable logic devices, and downloadable electrical signals. In addition, a computer program product that implements the subject matter described herein may be implemented on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a flow chart illustrating an exemplary process for associating resources using behaviors according to an embodiment of the subject matter described herein;

FIG. 2 is a block diagram illustrating an exemplary system for associating resources using behaviors according to an embodiment of the subject matter described herein;

FIG. 3 is a block diagram illustrating an exemplary database record that may be used to associate resources according to an embodiment of the subject matter described herein;

FIG. 4 is a block diagram illustrating a user interface for associating resources using behaviors according to an embodiment of the subject matter described herein;

FIG. 5 is a block diagram illustrating a user interface for associating resources using behaviors according to an embodiment of the subject matter described herein;

FIG. 6 is a block diagram illustrating a user interface for associating resources using behaviors according to an embodiment of the subject matter described herein;

FIG. 7 is a block diagram illustrating a user interface for associating resources using behaviors according to an embodiment of the subject matter described herein;

FIG. 8 is a block diagram illustrating a user interface for associating resources using behaviors according to an embodiment of the subject matter described herein; and

FIGS. 9A-9C are block diagrams illustrating a user interface for selecting behaviors for associating resources according to an embodiment of the subject matter described herein.

### DETAILED DESCRIPTION

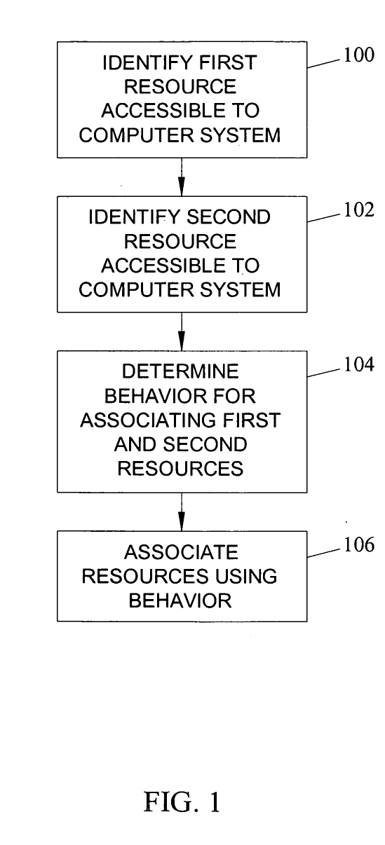

FIG. 1 is a flow chart illustrating an exemplary process for associating resources using behaviors according to an embodiment of the subject matter described herein. Referring to FIG. 1, in block 100, a first resource managed by a computer operating system is identified. In block 102, a second resource managed by the computer operating system is identified. Blocks 100 and 102 may be implemented by an application that receives user input for selecting the first and second resources.

In block 104, a behavior is determined for associating with first and second resources. For example, the behavior may be determined by the user by selecting a behavior from a plurality of behaviors presented to the user via a menu. In an alternate implementation, the behavior may be determined or selected by an application via an application programming interface (API). In yet another alternate implementation, the user may define a new behavior via an API made available by relationship manager software (described below).

The behavior may be independent from behaviors defined by a computer operating system for the first and second resources. For example, the Windows® XP operating system allows a user to specify an executable file that opens a type of non-executable file. The operating system has a predefined “open with” behavior associated with the executable file that the user may select and associate with the type of non-executable file. However, there is no ability in current operating systems to associate resources with each other at the instance level, rather than at the resource type level. In addition, there is no ability in current computer operating systems for allowing a user to define or select a behavior from a group of behaviors for associating resources at the instance level and/or resource type level. The subject matter described herein allows the user to create or select any number of behaviors for associating resources.

One example of a behavior that may be defined using the subject matter described herein includes a containment behavior where neither resource previously had a containment behavior. For example, it may be desirable to define a containment behavior for an image file so that the image file can contain other resources that have subject matter that is associated with the image file. In one example, the image file may be an image of a particular person. It may be desirable to associate resources relating to that person with the image file. The subject matter described herein allows a containment relationship to be defined for the image file and other resources to be associated with the image file via the containment relationship.

Once resources are associated using a behavior, the user may be able to navigate between the resources using the behavior or operate on one or more of the resources using the behavior tied to the associated resources. For example, a user may be able to select the image file and open any other file that is contained within the image file by right clicking on the image file and accessing a list of resources that are contained by the image file.

Another example of a behavior that may be created using the subject matter described herein includes a workflow behavior. For example, an image file may point to a list of executable files that are to be used to open the image file. For example, it may be desirable to first open and edit the image file using an image editor. It may then be desirable to publish the edited image, for example, via a web interface. In order to implement such a workflow relationship, the image file may first point to the image editor and then to a web publishing application. When the image file is first selected by a user, the image file may be opened via the image editor. When the image editor is terminated by the user, the edited image file may be automatically opened via the web publishing application.

According to another aspect of the subject matter described herein, a behavior for associating resources may be independent of an association between the first and second resources and a file system for storing the first and second resources. For example, current file systems include file folders that are capable of storing other files. Additional behaviors that are not defined by the file system may be defined and associated with the file folder. For example, a user may define a search behavior for a file folder so that when the file folder is created, it automatically searches for files that have names or that include content corresponding to the file folder name.

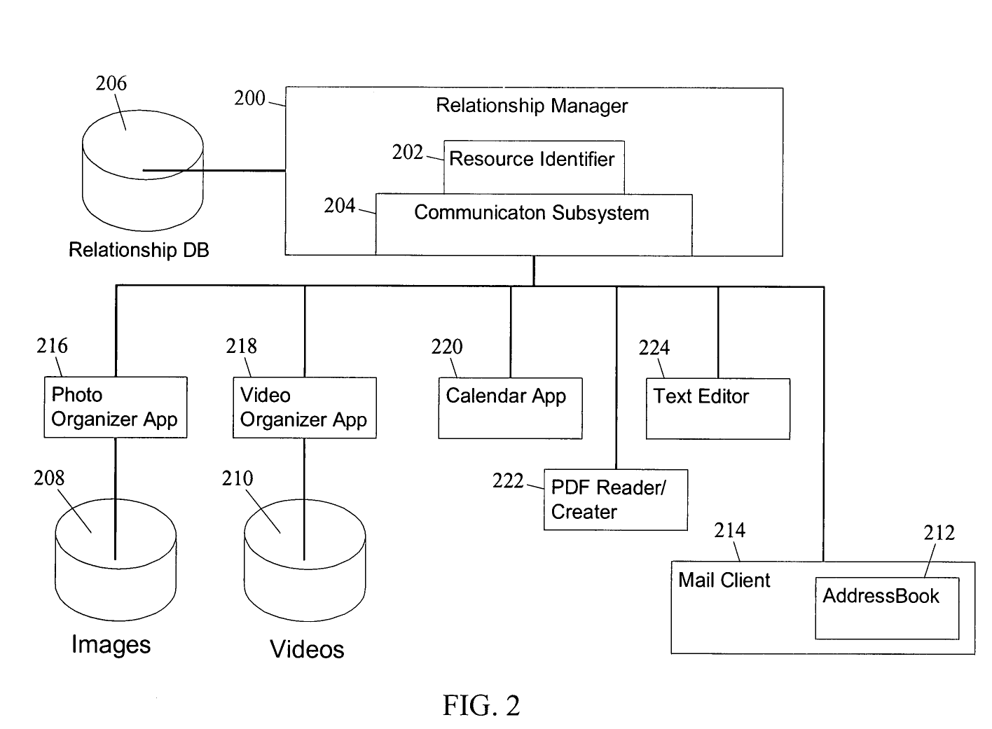

FIG. 2 is a block diagram illustrating an exemplary system for associating resources using behaviors according to an embodiment of the subject matter described herein. Referring to FIG. 2, the system includes a relationship manager 200 for managing relationships between system resources. In the illustrated example, relationship manager 200 includes a resource identifier 202 and a communications subsystem 204. Resource identifier 202 may identify resources selected by a user via a graphical user interface. Communication subsystem 204 may control communications between relationship manager 200 and other system resources.

In one exemplary implementation, relationship manager 200 may apply a default behavior for associating the resources if no behavior is specified by the user. For example, a default behavior for an image file associated with an image editor may be that the image file is to be opened with the image editor. A user may define a workflow behavior for the image file such that the image file is first opened using the image editor and then opened using a web publishing application. In this case the user associates the image file with the image editor first, then with the web publishing application choosing the same instance of the workflow behavior in both cases.

Relationship manager 200 may receive input from a user for defining behaviors and associating resources using behaviors via a graphical user interface or via a command line interface. For applications, relationship manager 200 may include an application programming interface that defines the association. The following is an example of an application programming interface that may be provided by relationship manager 200:
RelationID CreateRelation(Source, Stype, Destination, Dtype, Direction, Behavior);
DeleteRelation(RelationID)
UpdateRelation(RelationID, . . . )
Object=Get(resourceID)
   The above listed APIs correspond to functions for associating resources. In particular, the CreateRelation function allows the users to specify source resource, source resource type, destination resource, destination resource type, direction, and behavior. The CreateRelation( ) function returns a relation identifier. The DeleteRelation( ) and UpdateRelation( ) functions allow relations to be updated or deleted by applications. The Get( ) function allows relationship manager 200 to access a resource within an application that may be part of a relationship. This API is provided by an application to make resources available for participating in relationships.

The subject matter described herein is not limited to using an application programming interface to provide communication between relationship manager 200 and applications. In an alternate implementation, a publication/subscription (pub/sub) service with a well known API or protocol may be used for such communication.

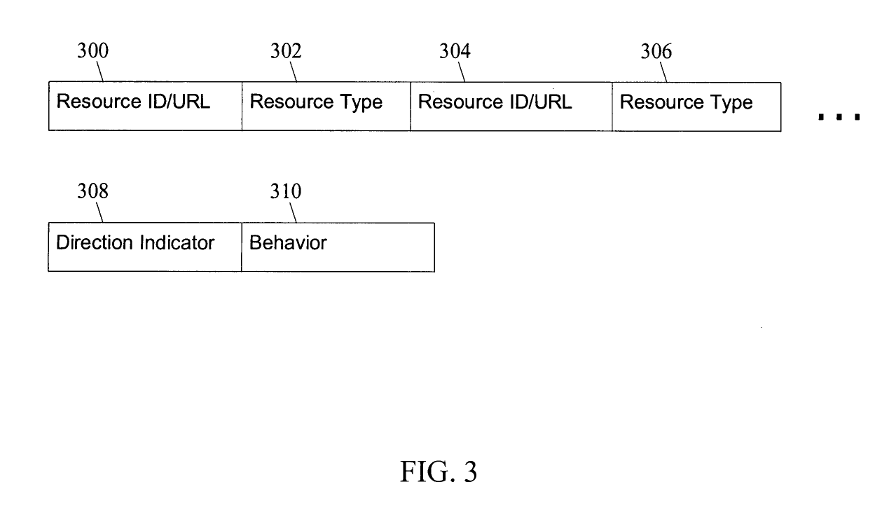

In the illustrated example, a relationship database 206 stores relationships created between resources based on behaviors. In an alternate implementation, the behaviors and corresponding relationships may be stored within the resources themselves. FIG. 3 illustrates an example of a record that may be included in relationship database 306. In FIG. 3, the record includes a resource ID field 300 for storing a resource identifier, a resource type field 302 for storing a resource type, a second resource identifier field 304 for storing identifier of an associated resource, a second resource type field 306 for storing the resource type of a resource that is associated with the resource, a direction indicator 308 that indicates the direction of the relationship, and a behavior field 310 that stores the behavior defining the relationship between the resources. It should be understood that more than two resources may be associated using a record and, as such, the record illustrated in FIG. 3 can be extended to include any number of resources and resource types. In addition, multiple behaviors may be included for each resource type.

In Windows® XP a relationship type is defined by the resource types of the endpoints of the relationships. Relationship types must be defined by a system programmer before the system can support a given type. Using relationship manager 200, if a relationship is specified by a user between two resource instances, and the relationship is not previously defined, i.e., not defined by the system programmer, relationship manager 200 is capable of supporting the new relationship type. For example, a user may select two resource instances and thereby create a relationship between the resource instances. The resource instances may be any suitable resource instances, such as document files. Initially, the relationship may be assigned a default behavior which is independent of the resource types. An example is the Association behavior which simply records that resources are related and can be used to navigate from one resource to the other.

Given that no specific behaviors have been associated with the new relationship type other than perhaps the default for new relationship types, relationship manager 200 may make a set of resource-type-independent behaviors available for further defining the relationship between the resource instances. The set of behaviors presented to the user may be also selected by relationship manager 200 based on the resource endpoint types. That is, some behaviors, such as “open with (target),” may only be applicable if the target is an executable resource. Alternatively, the user may manually define the behavior by writing computer code and creating an executable file that implements the behavior.

Once the behavior is created and associated with the relationship type, relationship manager 200 may prompt the user for the scope of the relationship. For example, the user may indicate that the relationship is only to apply to the selected resource instances at the instance level. Alternatively, the user may indicate that the relationship applies to all resources that match the endpoint resource instance types. The new relationship type may be stored by resource manager 200 for future use for associating different instances of resources of the same types as the resources for which the relationship type was originally defined.

In FIG. 2, exemplary resources that may be associated using behaviors include image files 208, video files 210, address book data 212 made accessible via mail client 214, and executable files, such as photo organizer application 216, video organizer application 218, calendar application 220, PDF reader/creator 222, and text editor 224. Any one or more of these resources can be associated with each other or with other resources not illustrated in FIG. 2 using behaviors. Specific user interface examples illustrating user actions for associating resources using behaviors will now be described.

The system illustrated in FIG. 2 may include means for identifying first and second resources accessible by a computer system. For example, resource identifier 202 may identify resources selected by the user via a GUI or other suitable interface. The system illustrated in FIG. 2 may further include means for receiving user input for selecting, from a plurality of different behaviors, a behavior for associating the first and second resources and for associating the first and second resources using the behavior. For example, relationship manager 200 may present a user with a menu including a plurality of behaviors for associating resources and receive user input selecting one or more of the behaviors. In response to the user input, relationship manager 200 may associate the resources using the behavior.

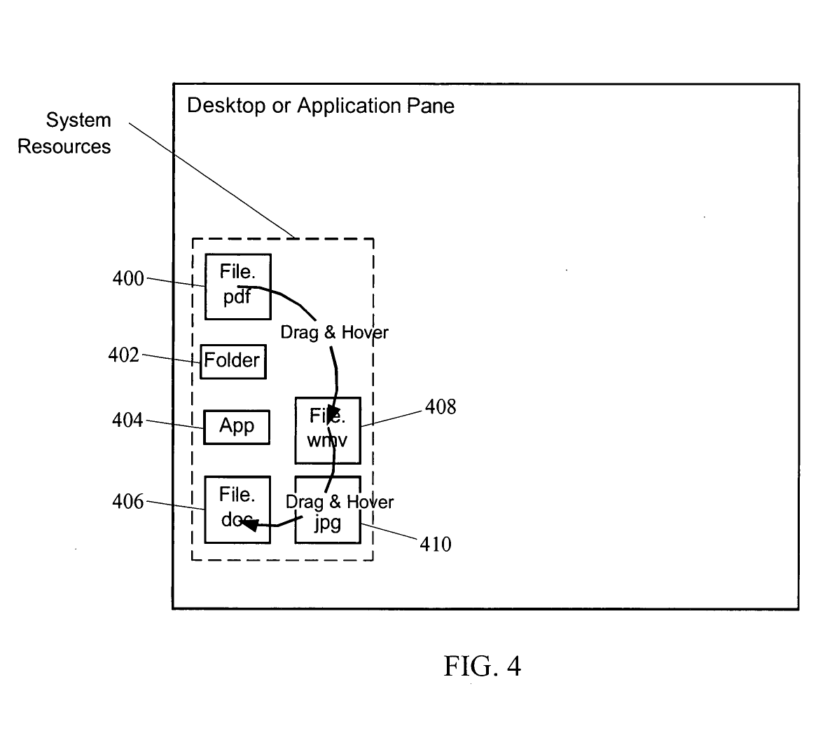

FIG. 4 is a block diagram illustrating an exemplary desktop or application pane that may be used by relationship manager 200 for associating resources using behaviors. In FIG. 4, the exemplary resources include a PDF file 400, a file folder 402, an executable file 404, a document file 406, a windows movie file 408, and a jpeg file 410. In the illustrated example, a user drags PDF file 400 and hovers the PDF file over any number of resources to create a relationship between the resources. As stated above, the relationship created may be based on a default behavior defined for the source and/or target resource types. For example, the default behavior for a PDF file may be that the PDF file is to be stored within the target resource. In addition, after the user hovers the source resource over a target resource for a predetermined time period, a dialog box may appear allowing the user to select or create the behavior for associating the resources. The behavior may either replace the default behavior or may be additive with respect to the default behavior. Confirmation that the resources have been associated may be provided by any suitable means, such as visible feedback, audible feedback, or tactile feedback.

The act of hovering a resource over another resource may be sufficient to indicate that a relationship is to be established. In an alternate implementation, a mouse gesture, such as a left or right mouse click, may be used to indicate that a relationship is to be established. Predetermined keys, such as the arrow keys, may be used to indicate the directionality of a relationship between resources. In addition, the drag and hover operation may be used to establish relationships between all resources hovered over. For example, if resource A is dragged and hovered over resources B and C, relationships may be created between A and B, A and C, and B and C.

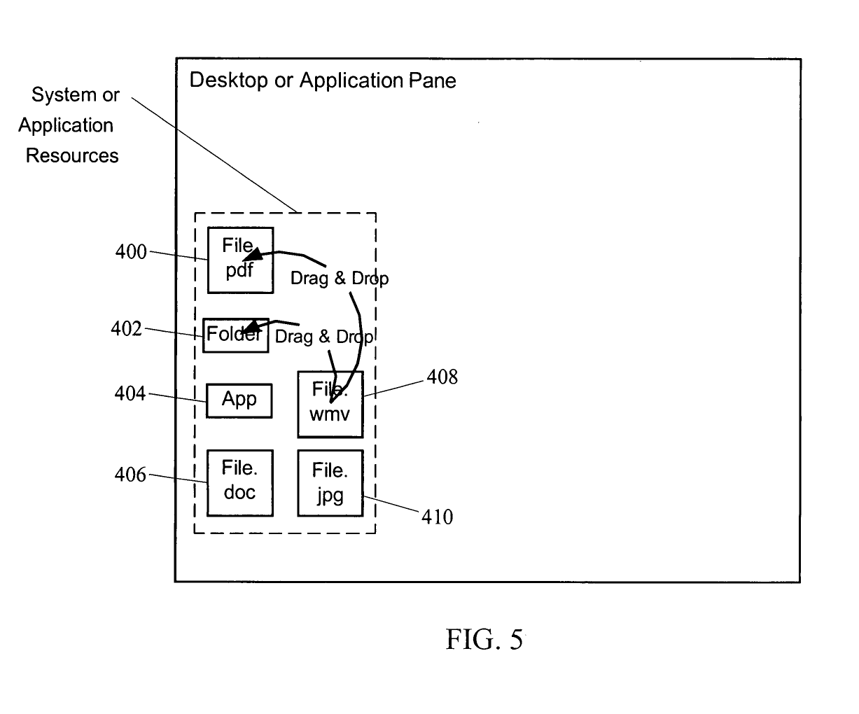

FIG. 5 is a block diagram illustrating a desktop or application pane that may be used by relationship manager 200 to associate resources using behaviors according to an embodiment of the subject matter described herein. In the example illustrated in FIG. 5, the user drags and drops source resources onto target resources to create relationships. The embodiment illustrated in FIG. 5 may operate the same as that illustrated in FIG. 4 except that a drag and drop action rather than a drag and hover action is used to create the association.

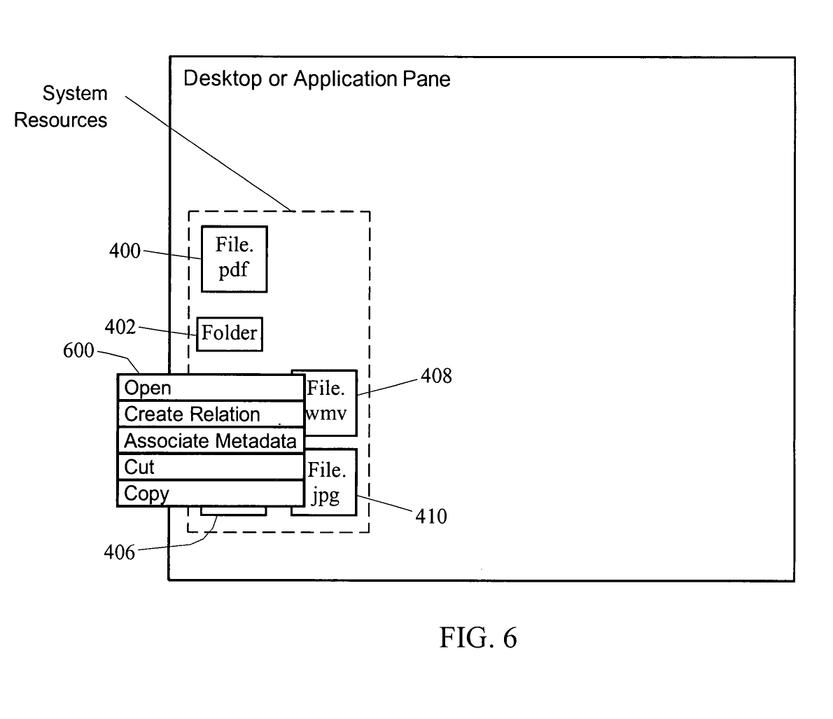

FIG. 6 illustrates yet another example of an exemplary desktop or application pane that may be provided by the operating system GUI and used by relationship manager 200 to initiate a resource association. In the example illustrated in FIG. 6, a user selects resources and a menu appears that allows the user to create a relation between the resources. When the user clicks on the “create relation” option in menu 600, user input may be interpreted in the context of the create relation mode of operation, rather than a normal mode of operation. For example, when a user selects a resource when in the create relation mode of operation, rather than performing the default context menu option for the resource, the user may be prompted to specify a behavior for associating two or more selected resources. The user may select any number of behaviors for associating resources. In addition, single relationships may be established between two groups of resources, single relationships may be established between each resource in a source group and each resource in a target group, single relationships may be established between a source group and each resource in a target group, and single relationships may be established between each resource in a source group and a target group.

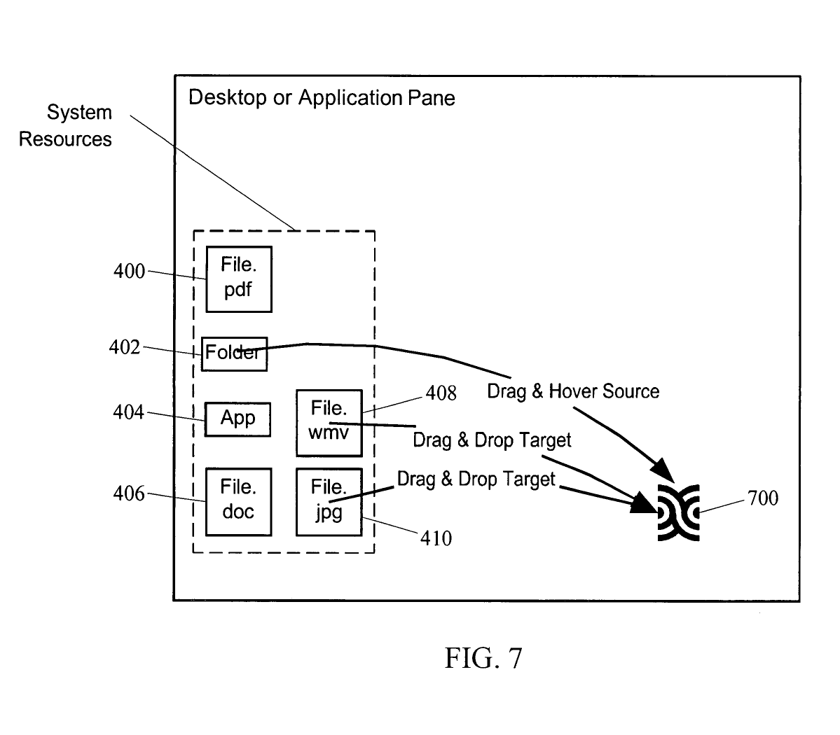

FIG. 7 illustrates yet another example of a desktop or application pane that may be displayed by the GUI of an operating system and used by relationship manager 200 to initiate an association process. In the illustrated example, the desktop or application pane includes a resource associator 700 that allows the user to select resources and associate the resources by dragging the resources over associator 700 and dropping the resources onto associator 700. Alternatively, the user may drag and hover the resource over associator 700. The result of drag and drop or drag and hover actions with regard to associator 700 is that the selected resources may be associated with each other. In the illustrated example, associator 700 has two sides—one for source resources and one for target resources. Rather than using two sides, a mouse gesture may be used to indicate a source resource and a different mouse gesture can be used to indicate a target resource. Once resources are associated with associator 700, the user may click on associator 700 to define the behavior for associating the resources.

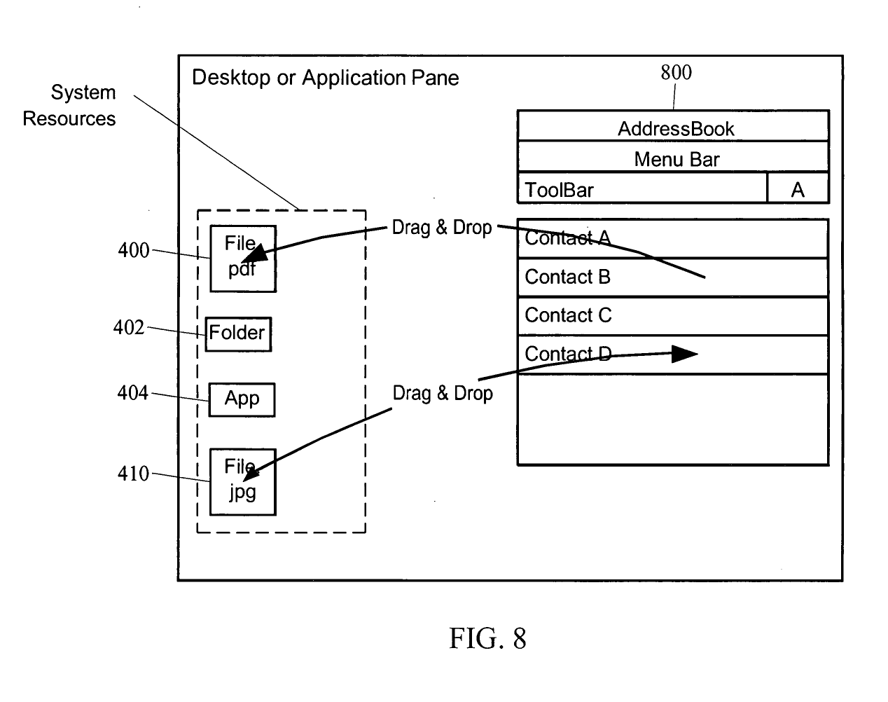

FIG. 8 illustrates yet another example of a desktop or application pane that may be provided by an operating system GUI and used by relationship manager 200 to associate resources. In the illustrated example, file resources are being associated with entries in an address book 800 made available via an email application. In one example, the contact B entry is being associated with a PDF file by dragging the contact B entry and dropping the contact B entry onto the PDF file. In another example, a bi-directional relationship is being created between a contact D entry and a jpeg file. Again, the user may specify behaviors from a list of behaviors for associating the resources.

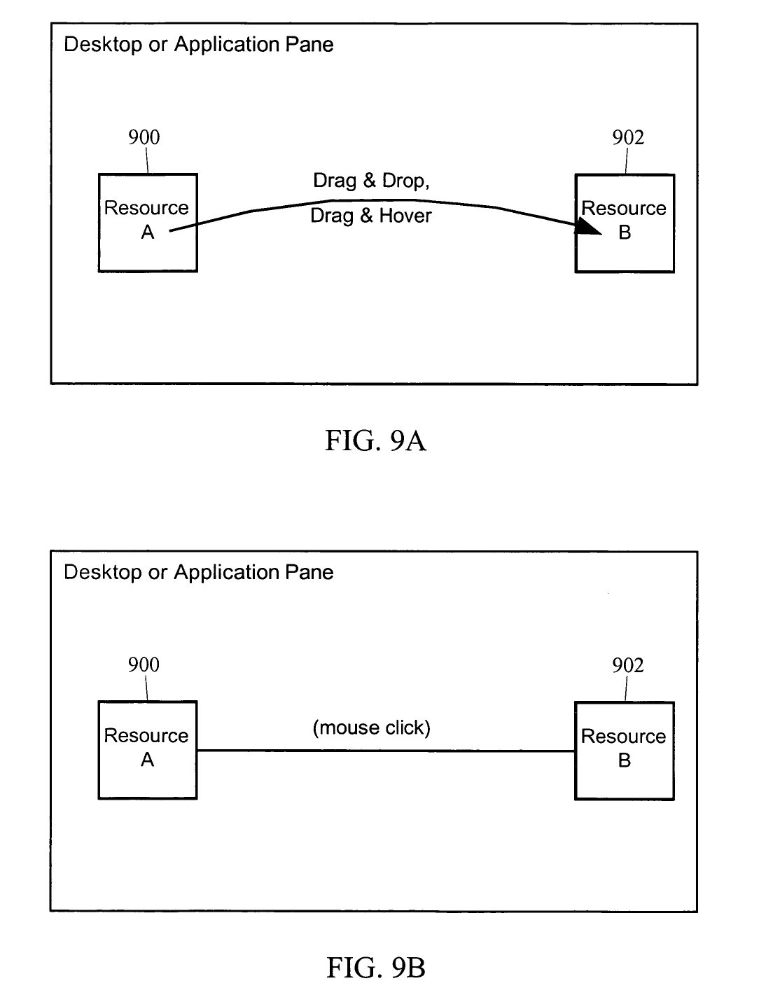

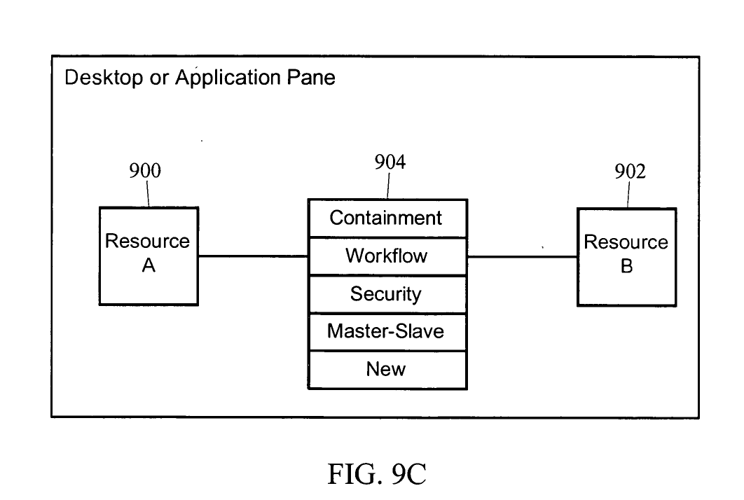

FIGS. 9A-9C illustrate exemplary desktop or application panes showing a sequence of actions by which a user may associate two resources and define association behaviors according to an embodiment of the subject matter described herein. Referring to FIG. 9A, a user may associate a first resource 900 with a second resource 902 using any of the actions described above, such as drag and drop, drag and hover, etc. Referring to FIG. 9B, once the association is made, relationship manager 200 may provide a visual indication between the resources indicating that the resources are associated with each other. In the illustrated example, the visual indication is a line joining the graphical representations of the resources on the desktop or application pane.

In order to define a behavior for the association, the user may select the visual indication of the resource association, for example using a mouse click operation. Referring to FIG. 9C, once the user clicks on the visual indication of the resource association, a behavior menu 904 may be displayed. Behavior menu 904 specifies a plurality of behaviors that the user can use to associate the resources. In the illustrated example, the behaviors include containment, workflow, security, master-slave, and new. Examples of the containment and workflow behaviors are described above. A master-slave behavior may be a behavior that automatically updates a slave resource each time a master resource is updated. For example, an author may define one document file as a master resource and another document file as a slave resource so that changes to the master document file will automatically be made to the slave document file.

A security behavior may be an action where access to a second resource is conditioned on a user passing security measures associated with a first resource. For example, access to a first resource may be conditional on a user providing a user name and a password. If a user provides a user name and a password and is granted access to the first resource, the user may be automatically granted access to the second resource. Conversely, if the user is not granted access to the first resource, the user may be automatically denied access to the second resource.

If the user selects one of the behaviors other than “new”, then that behavior will be used to associate the resources. If the user selects the new behavior, the user may define a new behavior using an application programming interface provided by relationship manager 200.

The following scenarios may be implemented by relationship manager 200 to associate resources using behaviors according to an embodiment of the subject matter described herein.

Scenario 1:
1. Larry has a picture of Moe on his desktop. He wants to be able to find all the resources related to Moe through this picture.
2. Larry uses his system search tool to find all resources either with “Moe” in the content or “Moe” in the metadata.
3. He drags and drops the picture of Moe onto the group of resources returned. Moe could have used a mouse gesture over the group to change the direction of the relations or a different gesture to make the relations bidirectional.
4. Now Larry can select Moe's picture and request to see all the resources related to the picture. The resources related to the picture may have further relationships to other resources allowing navigation to them as well.

Scenario 2:
1. Larry has a picture of Moe on his desktop. However, there is no metadata related to Moe associated with the picture.
2. Larry opens his address book and locates Moe's address book record.
3. He drags Moe's picture over the address book entry creating a relationship from Moe's picture to the entry. Larry uses the mouse to hover over the entry until the entry indicates that it has focus and a roll-over display pops us showing new relationship and its directionality. Larry can make the relationship bidirectional by performing the same operation from the entry to the image, or by editing the properties of the relationship.
4. The picture was taken at Churchill Downs racetrack. Larry pulls up the home page for the track in his browser. He selects the image and drags and hovers it over the URL in the location bar to create a relationship from the picture to the URL of the web page.

Scenario 3:
1. Jonathan John Johnson's (JJJ) hobby is digital photography. He carefully works with every image he captures to make it perfect, to present it perfectly, and to categorize so it can be found easily and associated easily with related images. He uses three different software tools for this task: Advance Image Editor (AIE), Image Organizer (IO), and Web Page Builder (WPB).
2. To simplify this task JJJ wants to integrate the use of the three applications into a workflow process. He can do this through relating the applications used for each task using workflow relationships.
3. JJJ selects AIE with the mouse and drags and drops it on IO on his desktop while in relationship mode. A line from AIE to IO is displayed along with a pop-up list of behaviors compatible with two .exe resource types is displayed. JJJ selects “WorkFlow” behavior. Workflow behavior takes the output of the first resource and invokes the second resource passing the output from the first resource as input. He is allowed to name the workflow, rather than take the default “workflow” name. He names it “MyImagingProcess”.
4. JJJ then selects IO and drags and drops it on WPB. Again a connector is displayed with a pop-up of compatible behaviors. The named workflow “MyImagingProcess” is now in the list and is selected by JJJ. Thus AIE->IO->WPB define a workflow involving the three executable resources wherein the output of a source executable is passed as input to its target executable resource as identified by the instance of the Workflow relation defined.
5. JJJ also specifies that MyImagingProcess is the default action for the AIE resource. This means that any image that is dragged and dropped onto AIE enters the MyImagingProcessWorkflow. The AIE application opens using the image. The user edits the image. On save and exit, the IO application is invoked with the saved results from the AIE application. The user can now provide metadata and place the image in various categories, containers, etc. On save and exit, the WPB application is open with the image as input along with metadata assigned by the IO app. The user can construct a web presentation using the image, current presentations known to WPB, and WPB can take some automated actions using the metadata if it is enabled.

Scenario 4:
1. Don Donnelly (DD) is the project manager for his team at work.

He has a lot of loose files that his project manager software doesn't manage and needs a way to tie them together.
2. DD right-clicks on one of the files that is associated with the project. He selects the Create new Project context menu action. He is prompted for a project name which he provides.
3. An icon is created on DD's desktop with the project name provided and a connector is displayed from the icon to the icon for the file DD originally selected.
4. DD can now drag and drop project files onto the project resource icon. For each file a relationship is created between the project resource and the file and is assigned the default “Project” behavior.
5. The Project behavior adds a number of actions to resources in the project. Examples include:
   a. View project resources
   b. View timeline (shows a graph with lines showing the creation date of each resource and the update dates (if known) for each resource. DD can mark a resource as complete and add other properties, such as dependencies, target end date, resources assigned, etc.
   c. Send email to team (if resources have been defined)

It will be understood that various details of the subject matter described herein may be changed without departing from the scope of the subject matter described herein. Furthermore, the foregoing description is for the purpose of illustration only, and not for the purpose of limitation.

What is claimed is:

1. A method for associating computer-system-accessible resources at an instance level, the method comprising:
identifying a first resource accessible by a computer system;
identifying a second resource accessible by the computer system;
determining a behavior for associating the first and second resources at an instance level; and
associating the first and second resources at the instance level using the behavior, wherein the behavior is independent of an association between the first and second resource instances and a file system for storing the first and second resource instances.

2. The method of claim 1 wherein identifying the first and second resources includes receiving user input for selecting the first and second resources via a graphical user interface (GUI).

3. The method of claim 2 wherein receiving user input for selecting the first and second resources via the GUI includes receiving user input for dragging the first resource over the second resource and dropping the first resource onto the second resource.

4. The method of claim 2 wherein receiving user input for selecting the first and second resources via the GUI includes receiving user input for dragging the first resource to a location corresponding to the second resource and hovering the first resource over the second resource.

5. The method of claim 2 wherein receiving user input for selecting the first and second resources via the GUI includes receiving user input for selecting the first and second resources and presenting a user with a context menu for associating the first and second resources.

6. The method of claim 2 wherein receiving user input for selecting the first and second resources via the GUI includes receiving user input for selecting the first and second resources and for associating the first and second resources using a graphical resource associator.

7. The method of claim 1 wherein the first and second resources comprise files.

8. The method of claim 7 wherein the files comprise non-executable files.

9. The method of claim 7 wherein the files comprise executable files.

10. The method of claim 7 wherein the first resource comprises an executable file and the second resource comprises a non-executable file.

11. The method of claim 1 wherein the first resource comprises a file and the second resource comprises data available via an executing application.

12. The method of claim 1 wherein determining a behavior includes determining a containment behavior for associating the first and second resources wherein the first resource is contained by the second resource.

13. The method of claim 1 wherein the determining a behavior includes determining a workflow behavior wherein the first resource is opened using the second resource.

14. The method of claim 13 wherein the workflow behavior specifies a third resource for opening the first resource in response to closing the first resource using the second resource.

15. The method of claim 1 wherein determining a behavior includes determining a security behavior wherein access to the second resource depends on access to the first resource via at least one security behavior defined for the first resource.

16. The method of claim 1 wherein determining a behavior includes determining a master-slave behavior wherein changes to the first resource are automatically made to the second resource.

17. The method of claim 1 wherein determining a behavior includes selecting the behavior from a menu including a plurality of different behaviors.

18. The method of claim 1 wherein determining a behavior includes creating the behavior using an application programming interface.

19. The method of claim 1 wherein determining a behavior includes requesting that the user select a behavior, and, in response to failing to receive a selection from the user, assigning a default behavior.

20. The method of claim 1 wherein associating the first and second resources using the behavior includes establishing a unidirectional relationship between the first and second resources using the behavior.

21. The method of claim 1 wherein associating the first and second resources using the behavior includes establishing a bidirectional relationship between the first and second resources using the behavior.

22. The method of claim 1 comprising navigating between the first and second resources using the behavior.

23. A method for associating computer-system-accessible resources using behaviors, the method comprising:
identifying first and second resources accessible to a computer system;
receiving user input for establishing a relationship between the selected resources;
identifying a behavior to associate with the relationship;
associating the behavior with the relationship and thereby creating a new relationship type for associating the first and second resources; and
associating the first and second resources using the new relationship type.

24. The method of claim 23 comprising prompting the user for a scope to be applied to the new relationship type, receiving input from the user regarding a scope to be applied to the relationship and wherein associating the resources includes associating the resources at a level corresponding to the scope received from the user.

25. The method of claim 23 wherein identifying a behavior includes receiving user input for selecting a behavior from a plurality of behaviors.

26. The method of claim 23 wherein identifying a behavior includes selecting a default behavior based on types of the first and second resources.

27. A method for associating computer-system-accessible resources using behaviors, the method comprising:
identifying a first resource accessible to a computer system;
identifying a second resource accessible to the computer system; and
receiving user input for selecting, from a plurality of different behaviors, a behavior for associating the first and second resources; and
associating the first and second resources using the behavior.

28. A system for associating computer-system-accessible resources at an instance level using behaviors, the system comprising:
a resource identifier for identifying first and second resources accessible by a computer system; and
a relationship manager operatively associated with the resource identifier for determining a behavior for associating the first and second resources at an instance level and for associating the first and second resources at the instance level using the first behavior, wherein the first behavior is independent of an association between the first and second resource instances and a file system for storing the first and second resource instances.

29. The system of claim 28 wherein the resource identifier is adapted to receive user input for selecting the first and second resources via a graphical user interface (GUI).

30. The system of claim 29 wherein the. resource identifier is adapted to receive user input for dragging the first resource over the second resource and dropping the first resource onto the second resource.

31. The system of claim 29 wherein the resource identifier is adapted to receive user input for dragging the first resource to a location corresponding to the second resource and hovering the first resource over the second resource.

32. The system of claim 29 the resource identifier is adapted to receive user input for selecting the first and second resources and to present a user with a context menu for associating the first and second resources.

33. The system of claim 29 wherein the resource identifier is adapted to receive user input for selecting the first and second resources to associate the first and second resources using a graphical resource associator.

34. The system of claim 28 wherein the first and second resources comprise files.

35. The system of claim 34 wherein the files comprise non-executable files.

36. The system of claim 34 wherein the files comprise executable files.

37. The system of claim 34 wherein the first resource comprises an executable file and the second resource comprises a non-executable file.

38. The system of claim 34 wherein the first resource comprises a file and the second resource comprises data available via an executing application.

39. The system of claim 28 the resource identifier is adapted to determine a containment behavior for associating the first and second resources wherein the first resource is contained by the second resource.

40. The system of claim 28 wherein the resource identifier is adapted to determine a workflow behavior wherein the first resource is opened using the second resource.

41. The system of claim 40 wherein the workflow behavior specifies a third resource for opening the first resource in response to closing the first resource using the second resource.

42. The system of claim 28 wherein the relationship manager is adapted to determine a security behavior wherein access to the second resource depends on access to the first resource via at least one security behavior defined for the first resource.

43. The system of claim 28 wherein the relationship manager is adapted to present a user with a menu including a plurality of different behaviors and to receive user input for selecting one of the behaviors.

44. The system of claim 28 wherein the relationship manager includes an application programming interface for determining the behavior.

45. The system of claim 28 wherein the relationship manager is adapted to allow navigation between the first and second resources using the behavior.

46. A system for associating computer-system-accessible resources using behaviors, the system comprising:
a resource identifier for identifying first and second resources accessible by a computer system; and
a relationship manager for receiving user input for selecting, from a plurality of different behaviors, a behavior for associating the first and second resources and for associating the first and second resources using the behavior.

47. A system for associating computer-system-accessible resources using behaviors, the system comprising:
means for identifying first and second resources accessible by a computer system; and
means for receiving user input for selecting, from a plurality of different behaviors, a behavior for associating the first and second resources and for associating the first and second resources using the behavior.

48. A computer program product comprising computer-executable instructions embodied in a computer-readable medium for performing steps comprising:
identifying a first resource accessible by a computer system;
identifying a second resource accessible by the computer system;
determining a behavior for associating the first and second resources at an instance level; and
associating the first and second resources at the instance level using the first behavior, wherein the first behavior is independent of an association between the first and second resource instances and a file system for storing the first and second resource instances.
